(19) United States
(12) Patent Application Publication
(10) Pub. No.: US 2011/0072922 A1
(43) Pub. Date: Mar. 31, 2011

(54) SLID TYPE COVER OPENING AND SHUTTING DEVICE FOR MOBILE PHONE

(75) Inventor: Seung-Hee Cho, Gyeonggi-do (KR)

(73) Assignee: Prexco Co., Ltd., Chungcheongnam-do (KR)

(21) Appl. No.: 12/992,819

(22) PCT Filed: Aug. 27, 2008
(86) PCT No.: PCT/KR2008/005027

§ 371 Date: Nov. 15, 2010

(30) Foreign Application Priority Data
May 26, 2008 (KR) 10-2008-0048832

(51) Int. Cl. F16H 21/44

(52) U.S. Cl. 74/100.2

(57) ABSTRACT

A slide-type cover opening and shutting device for a portable terminal according to an exemplary embodiment of the invention includes: a plate-shaped guide member; a plate-shaped movable member that is slidably assembled to the guide member, and an elastic member of which ends are rotatably connected to the guide member and the movable member, respectively. The elastic unit includes: i) a pair of rotary plates that cross in parallel with each other and are rotatably connected to the guide member and the movable member by hinge pins; ii) elastic support plates that are connected to both sides of the rotary plates between the rotary plates to be able to slide and lock, composed of first and second slide sections that are open to opposite directions toward the rotary plates, and that have a plurality of support pins that are partially inserted in the rotary plates at the first and second slide sections; and iii) elastic members that are fitted on the support plates and apply elastic reaction force to the rotary plates.

### TECHNICAL FIELD

The present invention relates to an exemplary embodiment of a portable terminal. More particularly, the present invention relates to a slide-type cover opening and shutting device for a portable terminal that allows the cover to slide up/down from a main body of the portable terminal.

### BACKGROUND ART

In general, portable terminals, such as mobile phones, PDAs, laptops, and DMB phones, are widely used for wireless services such as broadcasting and communication in a mobile fashion.

The portable terminal is becoming an important necessity for convenience in life with the development in the information industry, while mobile phones being are used by elementary school, middle school, and high school students to the old.

A variety of methods are used to open/shut a cover of the portable terminals, and they can be largely divided into a hinge type, a slide type, and a swing type.

In particular, portable terminals of which the covers are opened/shut in the slide type have several advantages, such as convenience, ease of operation, and refined design, such that the slide type has been the most widely used in recent years.

According to the basic structure of the portable terminal of which the cover is opened/shut in the slide type, the cover with a display slides up/down from the main body with a key pad, and manufacturers have recently manufactured slide-type opening/shutting devices for a portable terminal having various structures based on the basic structure.

As an example, a slide-type cover opening/shutting device for a portable terminal is composed of a guide member fixed to a main body, a movable member formed in a plate shape, fixed to the cover, and slidably combined with the guide member, and an elastic unit with both ends rotatably connected and supported to the movable member, wherein the guide member allows the movable member to easily and smoothly slide.

As a user applies a force to the cover until the movable member slides on a predetermined section while the cover of the portable terminal is open or shut, the elastic unit allows the cover to smoothly slide on the other section using an elastic return force.

However, according to the slide-type cover opening/shutting device of a portable terminal having the above configuration in the related art, a coil spring or a torsion spring is used as the elastic unit, in which the elastic unit contacts the guide member and the movable member when the cover slides to be opened and shut. Therefore, it has a problem in that the guide member and the movable member are damaged, such as by scratches, thereby causing problems in the opening/shutting thereof, such as noise or frictional resistance.

Further, the elastic unit in the related art may move up/down, which may cause problems in accurate and smooth opening/shutting.

The above information disclosed in this Background section is only for enhancement of understanding of the background of the invention and therefore it may contain information that does not form the prior art that is already known in this country to a person of ordinary skill in the art.

### DETAILED DESCRIPTION

### Technical Solution

In order to overcome the above problems, an exemplary embodiment of the present invention provides a slide-type cover opening and shutting device that accurately applies elastic force in the opening and shutting direction of the cover of the portable terminal, minimizes a decrease and loss of the elastic force, and stably moves and operates the elastic unit, and that can be easily manufactured with improved productivity.

A slide-type cover opening and shutting device for a portable terminal according to an exemplary embodiment of the invention includes: a plate-shaped guide member; a plate-shaped movable member that is slidably assembled to the guide member; and an elastic member of which ends are rotatably connected to the guide member and the movable member, respectively. The elastic unit includes: i) a pair of rotary plates that cross in parallel with each other and are rotatably connected to the guide member and the movable member by hinge pins; ii) elastic support plates that are connected to both sides of the rotary plates between the rotary plates to be able to slide and lock, composed of first and second slide sections that are open to opposite directions toward the rotary plates, and that have a plurality of support pins that are partially inserted in the rotary plates at the first and second slide sections; and iii) elastic members that are fitted on the support plates and apply elastic reaction force to the rotary plates.

In the slide-type cover opening and shutting device for a portable terminal, the elastic support plates may be formed to open ends of the first and second slide sections, corresponding to both sides of the rotary plates, and have hook protrusions that are hooked to both sides of the rotary plates.

In the slide-type cover opening and shutting device for a portable terminal, each of the rotary plates may have a guide rail where the first and second slide sections are slidably connected at both sides thereof, and locking projections are formed on the guide rail to lock the hook protrusions.

In the slide-type cover opening and shutting device for a portable terminal, the hook protrusion may have a predetermined inclination to be combined with the locking projection.

In the slide-type cover opening and shutting device for a portable terminal, the guide rail may be composed of a first rail facing the inside of open ends of the first and second slide sections from the locking projection, and a second rail facing the outside of the open ends.

In the slide-type cover opening and shutting device for a portable terminal, it is preferable that the open ends of the first and second slide sections are rounded.

In the slide-type cover opening and shutting device for a portable terminal, the elastic support plate may include: a first rib that is slidably connected to a side of the rotary plate corresponding to the first slide section; a second rib that is slidably connected to a side of the other rotary plate corresponding to the second slide section; and a third rib that is slidably connected to the other side of rotary plates between the first rib and the second rib, and is integrally formed with the first rib and the second rib.

In the slide-type cover opening and shutting device for a portable terminal, the elastic support plate may be formed in an S-shape.

In the slide-type cover opening and shutting device for a portable terminal, it is preferable that the elastic support plate is formed of a thin metal plate having elasticity.

In the slide-type cover opening and shutting device for a portable terminal, each of the rotary plates may have a main body with insertion holes where the support pins are inserted, and an extension that extends from both sides of the main body at the sides of the insertion holes.

Hinge grooves may be formed in the main body of the rotary plates to fit the hinge pins.

### BRIEF DESCRIPTION OF THE DRAWINGS

The drawings illustrate exemplary embodiments of the present invention and are not construed to limit any aspect of the invention.

FIG. 1 is a drawing showing an example of a portable terminal having a slide-type cover according to an exemplary embodiment of the present invention.

FIG. 2 is a perspective view illustrating the configuration of a slide-type cover opening and shutting device for a portable terminal according to an exemplary embodiment of the present invention.

FIG. 3 is an exploded perspective view of FIG. 2.

FIG. 4 is a perspective view showing an elastic unit that is applied to a slide-type cover opening and shutting device for a portable terminal according to an exemplary embodiment of the present invention.

FIG. 5 is an exploded perspective view of FIG. 4.

FIG. 6 is a cross-sectional schematic view showing a rotary plate that is applied to a slide-type cover opening and shutting device for a portable terminal according to an exemplary embodiment of the present invention.

FIG. 7 is a plan schematic view showing an elastic support plate that is applied to a slide-type cover opening and shutting device for a portable terminal according to an exemplary embodiment of the present invention.

FIG. 8 is a plan schematic view illustrating a slide-type cover opening and shutting device for a portable terminal according to an exemplary embodiment of the invention, in which the cover of the portable terminal is fully closed.

FIG. 9 is a plan schematic view illustrating a slide-type cover opening and shutting device for a portable terminal according to an exemplary embodiment of the invention, in which the cover of the portable terminal is half open.

FIG. 10 is a side schematic view illustrating a slide-type cover opening and shutting device for a portable terminal according to an exemplary embodiment of the invention, in which the cover of the portable terminal is half open.

FIG. 11 is a plan schematic view illustrating a slide-type cover opening and shutting device for a portable terminal according to an exemplary embodiment of the invention, in which the cover of the portable terminal is fully open.

FIG. 12 is a side schematic view illustrating a slide-type cover opening and shutting device for a portable terminal according to an exemplary embodiment of the invention, in which the cover of the portable terminal is fully open.

### BEST MODE

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention.

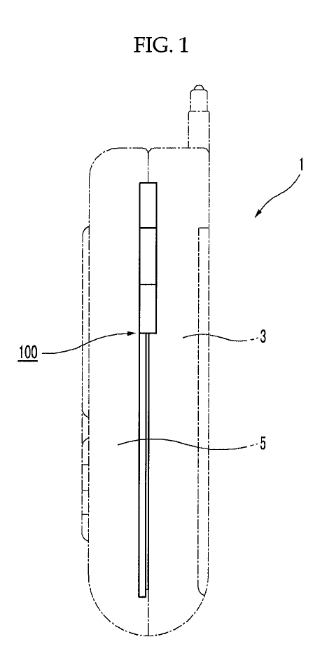

FIG. 1 is a drawing showing an example of a portable terminal having a slide-type cover according to an exemplary embodiment of the present invention.

Referring to the figure, as a portable terminal 1 having a slide-type cover opening and shutting device 100 according to an exemplary embodiment of the present invention, a up-down slide opening and shutting type of mobile phone can be exemplified.

However, the portable terminal 1 is not limited to common mobile phones in an exemplary embodiment of the present invention, and may be PDA phones and DMB phones.

The portable terminal 1 is formed such that a cover 5 with a display can slide up/down from a main body 3 with a key pad.

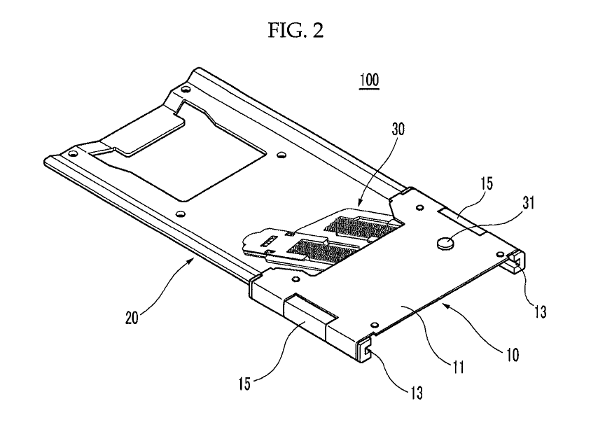

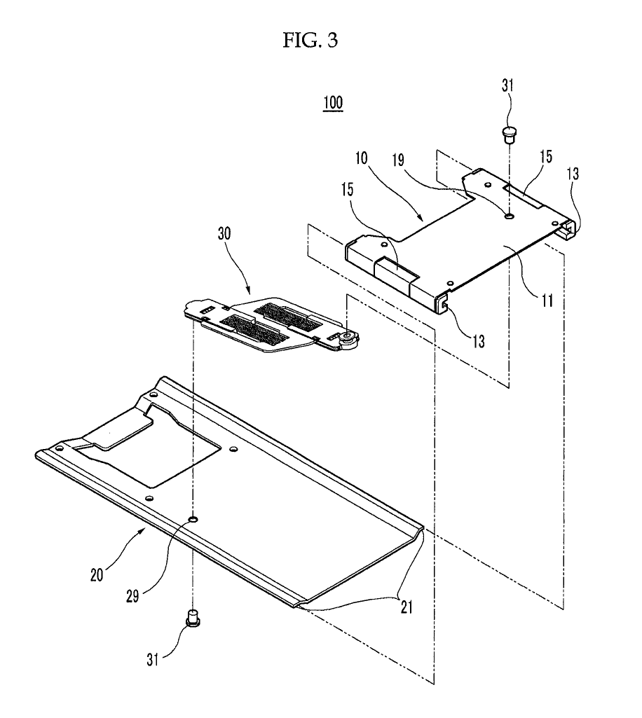

The slide-type cover opening and shutting device 100 for a portable terminal basically includes, as shown in FIGS. 2 and 3, a plate-shaped guide member 10, a plate-shaped movable member 20 that is slidably connected with the guide member 10, and an elastic unit 30 of which both ends are rotatably connected with the guide member 10 and the movable member 20.

The guide member 10 has a body 11 formed of a metal plate and a pair of groove members 15 made of synthetic resin, integrally fixed to both edges of the body 11, and having guide grooves 13.

The movable member 20 is made of metal or a synthetic resin and has a pair of rails 21, which are slidably fitted in the guide grooves 13, at both edges thereof.

The guide member 10 is mainly fixed to the main body (3: hereafter, refer to FIG. 1) of the portable terminal (1: hereafter, refer to FIG. 1), and the movable member 20 is mainly fixed to the cover (5: hereafter, refer to FIG. 1) of the portable terminal 1.

The guide member 10 and the movable member 20 may be achieved in the same configuration as those of guide members and movable members that are widely used for slide-type opening and shutting devices for portable terminals in the art.

The elastic unit 30, as stated in relation to the related art, allows the cover 5 to smoothly slide on the other section using an elastic return force as a user applies a force to the cover 5 until the movable member 20 slides on a predetermined section while the cover 5 of the portable terminal 1 is open or shut.

The elastic unit 30 can rotate about the guide member 10 and the movable member 20 by hinge pins 31, and for this, the guide member 10 and the movable member 20 have assembly holes 19 and 29 for fitting the hinge pins 31 in the elastic unit 30.

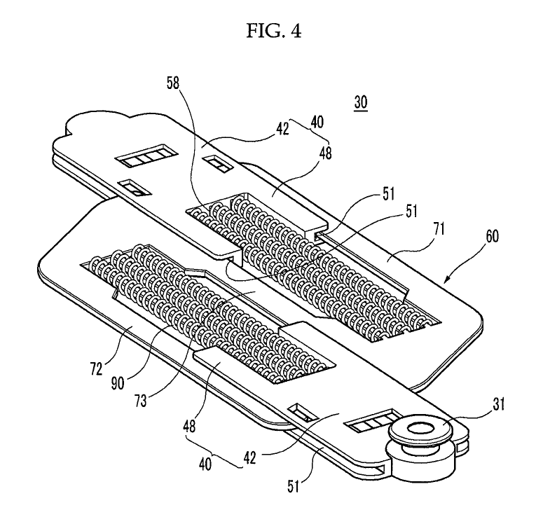

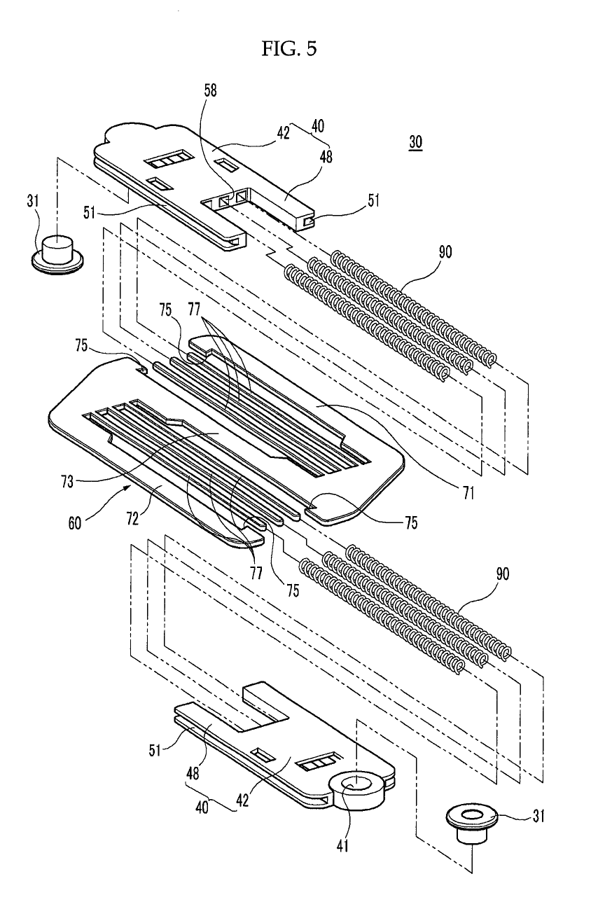

FIG. 4 is a perspective view showing the elastic unit shown in FIG. 3, and FIG. 5 is an exploded perspective view of FIG. 4.

Referring to the figures, in the slide-type opening and shutting device 100 for a portable terminal according to an exemplary embodiment of the present invention, the elastic unit 30 is largely composed of a pair of rotary plates 40, an elastic support plate 60, and an elastic member 90.

In this exemplary embodiment, the pair of rotary plates 40 cross in parallel with each other and are rotatably connected to the guide member (10: hereafter, refer to FIG. 3) and the movable member (20: hereafter, refer to FIG. 3) by the hinge pins 31, respectively.

That is, the pair of rotary plates 40 are disposed on a pair of parallel imaginary lines between the guide member 10 and the movable member 20, of which ends are disposed in the opposite directions.

Hinge grooves 41 where the hinge pins 31 are fitted are formed at the other ends of the pair of rotary plates 40, and the hinge grooves 41 are disposed opposite to each other in the up-down direction at the other ends.

The rotary plate 40 has a body 42 having the hinge groove 41 and an extension 48 that integrally extends from the longitudinal edge of the body 42.

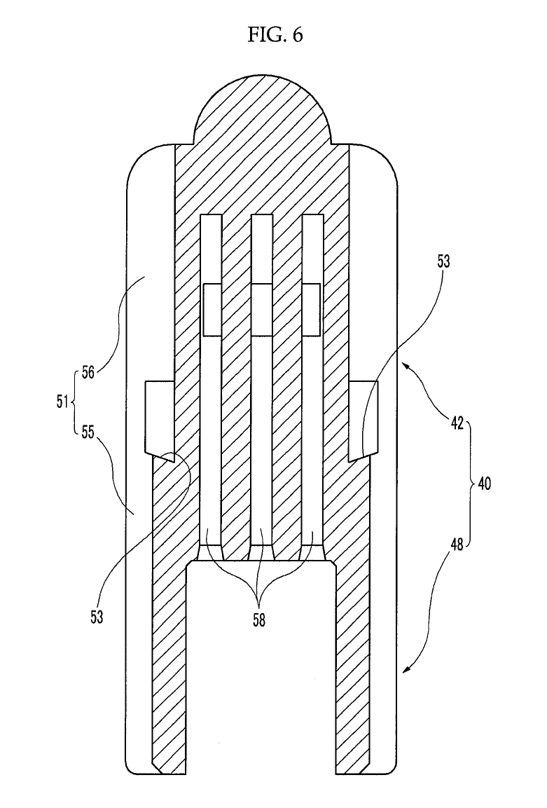

The rotary plate 40 has a guide rail 51, which is a groove having a U-shaped cross-section, at both sides and a locking projection 53 having a predetermined inclination is formed in the guide rail 51 as shown in FIG. 6.

The guide rail 51 is composed of a first rail 55 facing the extension 48 from the locking projection 53 and a second rail 56 facing the hinge groove (41: refer to FIG. 5) of the body 42.

The first rail 55 and the second rail 56 are different in depth because of the locking projection 53.

That is, the second rail 56 is larger in depth than the first rail 55 because of the locking projection 53.

On the other hand, a plurality of insertion holes 58 are longitudinally formed at a side between the extensions 48 in the body 42 of each of the rotary plates 40 such that they are spaced apart from each other by a predetermined distance in the width direction of the body (refer to FIG. 6).

In this exemplary embodiment, the elastic support plate 60 guides rotation of the rotary plate 40 and allows the cover 5 to slide using an elastic return force, while being formed of a thin metal plate having elasticity and a predetermined thickness.

The elastic support plate 60 is slidably connected to the guide rails 51 at both sides between the rotary plates 40 and locked to the locking projections 53 on the guide rails 51.

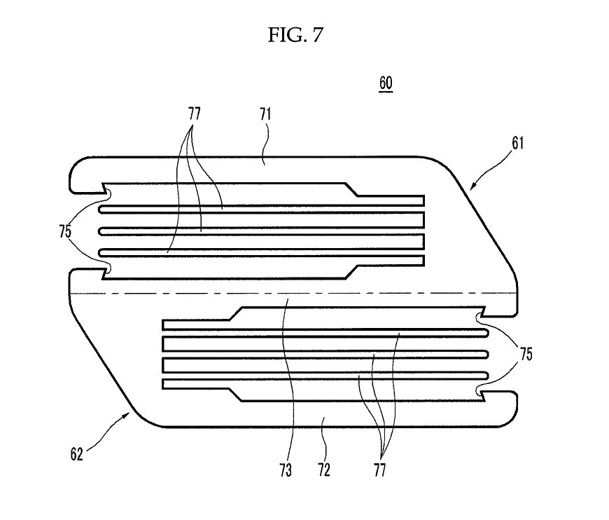

The elastic support plate 60, as shown in FIG. 7, is formed of a substantially S-shaped plate and composed of first and second slide sections 61 and 62 having open spaces facing the rotary plates 40 and disposed in opposite directions.

The first slide section 61 and the second slide section 62 are portions of the elastic support plate 60 formed of a single plate that is slidably connected to both of the guide rails 51 of the rotary plate 40.

That is, in this exemplary embodiment, from the one-point chain line in the figure, the section (part) that is slidably connected to the rotary plate 40 at a side is the first slide section 61 and the section (part) that is slidably connected to the rotary plate 40 at the other side is the second slide section 62.

Further, considering that the entire shape is the S-shape in this exemplary embodiment, the elastic support plate 60 has a first rib 71, a second rib 72, and a third rib 73 integrally formed with the first and second ribs 71 and 72 between the first and second ribs 71 and 72.

The first rib 71 is slidably connected to the guide rail 51 of the rotary plate 40 corresponding to the first slide section 61, and is integrally formed with an end of the third rib 73, from the open space of the first slide section 61.

The second rib 72 is slidably connected to the guide rail 51 of the other rotary plate 40 corresponding to the second slide section 62, and is integrally formed with the other end of the third rib 73, from the open space of the second slide section 62.

Further, the third rib 73, as described above, has the end integrally formed with the first rib 71 and the other end integrally formed with the second rib 72, such that it can be slidably connected to the other guide rail 51 of each of the rotary plates 40 at the center between the first rib 71 and the second rib 72.

Hook protrusions 75 that are hooked to the locking projections 53, as described above, are formed to correspond to the guide rails 51 of the rotary plate 40, at the open ends of the first and second slide sections 61 and, 62, that is, the open ends of the first rib 71 and the third rib 73, and the open ends of the second rib 72 and the third rib 73.

Each hook protrusion 75 has an inclination corresponding to the locking projection to be locked to the locking projection 53 between the first rail 55 facing the inside of the open ends of the first and second slide sections 61 and 62 and the second rail 56 facing the outside of the open ends.

That is, the hook protrusions 75 are inclined inside the open spaces of the first and second slide sections 61 and 62 at the open ends of the first and third ribs 71 and 73 and the open ends of the second and third ribs 72 and 73.

As described above, the inclination is given to each of the hook protrusions 75 and the locking projections 53 to prevent the rotary plates 40 from separating from the elastic support plate 60 when assembling the elastic support plate 60 with the rotary plates 40.

In this exemplary embodiment, since the elastic support plate 60 is formed of a thin metal plate having elasticity, the hook protrusions 75 can be locked to the locking projections 53 even if the hook protrusions 75 protrude at the open ends of the first and third ribs 71 and 73 and the open ends of the second and third ribs 72 and 73.

In detail, the assembly of the rotary plate 40 to the first and second slide sections 61 and 62 of the elastic support plate 60 is achieved while the first rib 71 and the second rib 72 elastically deform and slide on the first rail 55 and the hook protrusions 75 are locked to the locking projection 53 and then return to the initial shape, because the depth of the second rail 56 is larger than that of the first rail 55 because of the locking projections 53.

Further, in this exemplary embodiment, it is preferable to round the edges of the open ends of the first rib 71 and the third rib 73 and the open ends of the second rib 72 and the third rib 73.

The reason why the edges of the opens ends are rounded is for the open ends to be easily inserted into the first rail 55 when assembling the rotary plate with the first and second slide sections 61 and 62.

That is, it is for improving ease in assembly of the elastic support plate 60 with the rotary plates 40.

Meanwhile, in the elastic support plate 60, a plurality of support pins 77, which are partially inserted into the insertion holes 58 of the body 42 between the extensions 48 of the rotary plates 40, are formed in the first and second slide sections 61 and 62.

The support pins 77 support the slide motion of the elastic support plate 60 with respect to the rotary plates 40 while firmly supporting the elastic members 90, which are described below.

The support pins 77 are integrally formed to correspond to the open ends, at the connecting portion of the first rib 71 and the third rib 73 and the connecting portion of the second rib 72 and the third rib 73.

The number of support pins 77 is determined to correspond to the numbers of insertion holes 58 of the rotary plates 40 and the elastic members 90, which are described below.

In this exemplary embodiment, the elastic members 90, as shown in FIG. 4 and FIG. 5, are fitted on the support pins 77 of the first and second slide sections 61 and 62 and apply an elastic reaction force to the rotary plates 40.

It is preferable that the elastic member 90 is a compression spring.

The elastic members 90 are fitted on the support pins 77, and ends thereof are supported by the inlet of the insertion holes 58 and the other ends thereof are supported by the connecting portion of the first rib 71 and the third rib 73 and the connecting portion of the second rib 72 and the third rib 73, with the support pins 77 partially inserted in the insertion holes 58 of the rotary plates 40.

The assembly order and operation of the slide-type cover opening and shutting device 100 for a portable terminal having the above configuration according to an exemplary embodiment of the present invention is described hereafter.

Describing the assembly order of the slide-type cover opening and shutting device 100 for a portable terminal according to an example of the present invention, first, in this embodiment, the elastic members 90 are fitted on the support pins 77 of the slide sections 61 and 62 through the open ends of the first rib 71 and the third rib 73 and the open ends of the second rib 72 and the third rib 73.

Thereafter, the rotary plate 40 are assembled to the first and second slide sections 61 and 62 through the open ends of the first rib 71 and the third rib 73 and the open ends of the second rib 72 and the third rib 73.

Describing the above process in detail, first, the hook protrusions 75 at the open ends of the first rib 71 and the third rib 73 and the open ends of the second rib 72 and the third rib 73 are inserted into the first rails 55 of the rotary plates 40.

Since the elastic support plates 60 are formed of thin metal plates having elasticity, the first rib 71 and the second rib 72 are elastically deformed by the hook protrusions 75 and slide along the first rails 55 while being inserted into the first rails 55, and the hook protrusions 75 are locked to the locking projections 53, and returns to the initial shape. As a result, the hook protrusions 75 are hooked to the locking projections 53.

During the above process, the support pins 77 of the first and second slide sections 61 and 62 are partially and smoothly inserted into the insertion holes 58 of the rotary plate 40 and the elastic members 90 apply elastic reaction force to the rotary plates 40 while being compressed by the rotary plates 40.

Therefore, the rotary plates 40 are connected with the elastic support plates 60 while being elastically supported through the above process, and thereby assembly of the elastic unit 30 is finished.

After the assembly of the elastic unit 30 is finished, the rotary plate 40, as shown in FIGS. 2 and 3, is rotatably connected to the guide member 10 and the movable member 20 by the hinge pins 31 fitted in the hinge grooves 41 of the rotary plates 40 through the assembly holes 19 and 29 of the guide member 10 and the movable member 20.

The operation of the slide-type cover opening and shutting device 100 for a portable terminal equipped with the elastic unit 30 rotatably connected to the guide member 10 and the movable member 20 through the above process, according to an exemplary embodiment of the present invention, is described hereafter with reference to the figures.

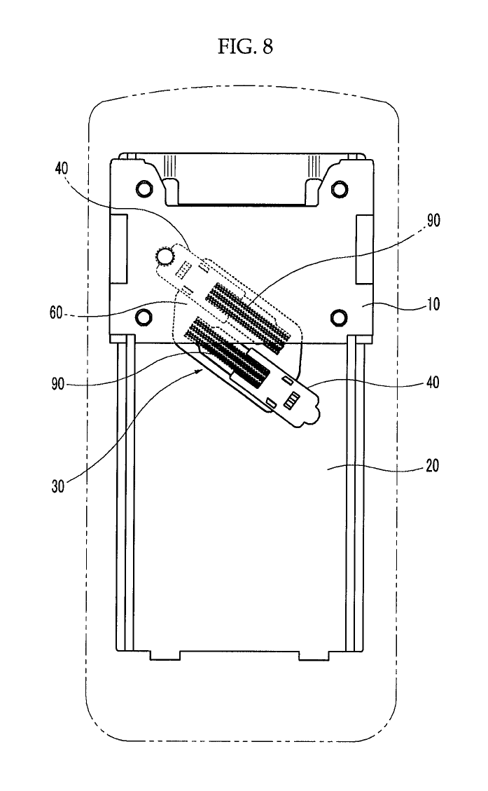

First, as shown in FIG. 1 and FIG. 8, with the cover 5 closed to the main body 3 of the portable terminal 1, the ends (upper portion) of the guide member 10 and the movable member 20 are connected and the rotary plates 40 of the elastic unit 30 are inclined in the movement direction of the cover 5.

Further, elastic force is not applied to the elastic members 90 or relatively small elastic reaction force is applied to the rotary plate 40.

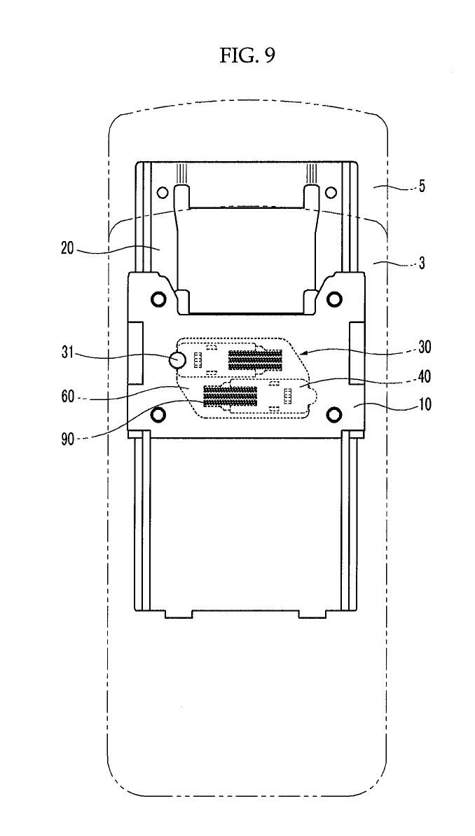

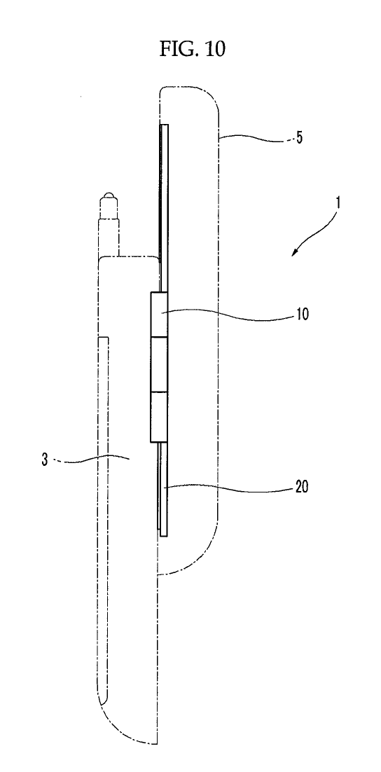

In this position, as shown in FIG. 9 and FIG. 10, as the cover 5 is pushed up from the main body 3 until it is half opened, the guide member 10 moves to the middle portion of the movable member 20.

Further, the rotary plates 40 of the elastic unit 30 rotate about the hinge pins 31 and are positioned substantially perpendicular to the movement direction of the cover 5.

In this position, as the elastic support plates 60 of the elastic unit 30 slide to the hinge pins 31 along the guide rails (51: hereafter, refer to FIG. 4) of the rotary plates 40 while being locked to the locking projections (53: hereafter, refer to FIG. 6), the elastic members 90 are compressed and the elastic reaction force of the elastic members 90 is increased. Accordingly, even though a user does not apply more force to the cover 5, the movable member 20 continues moving upward.

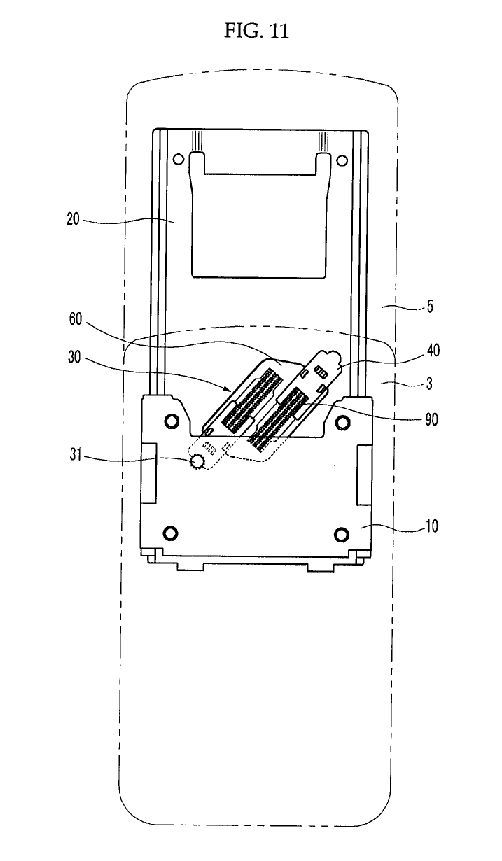

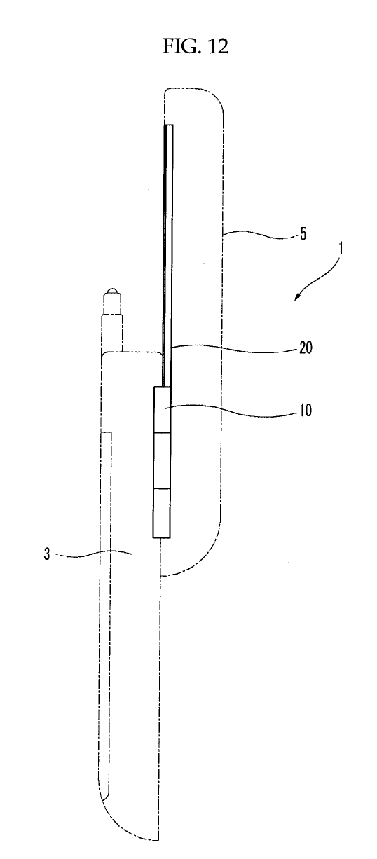

As the movable member 20 moves up as described above, as shown in FIG. 11 and FIG. 12, the guide member 10 moves to the other end (lower portion) of the movable member 20 and the cover 5 is fully opened, while the rotary plates 40 of the elastic unit 30 rotate about the hinge pins 31 and are inclined in the movement direction of the movable member 20.

In this operation, the elastic support plates 60 of the elastic unit 30 slide along the guide rails 51 of the rotary plates 40 to the opposite side of the hinge pins 31 and are locked to the locking projections 53, and the elastic members 90 decrease in elastic reaction force or the elastic reaction force is removed while returning to the initial shape as when the cover 5 is closed.

On the other hand, in this exemplary embodiment, closing the cover 5 that is open from the main body 3 of the portable terminal 1 is achieved in the inverse order of the above operation, such that it is not described in detail below.

As a result, in this exemplary embodiment, the elastic support plate 60 formed of one plate and the pair of rotary plates 40 are slidably connected and the elastic member 30 having the elastic members 90 supported by the support pins 77 of the elastic support plate 60 is provided, such that the elastic force of the elastic members 90 is accurately applied in the opening and shutting direction of the portable terminal 1.

Further, in this exemplary embodiment, it is possible to prevent the elastic force from being decreased or removed by bending or moving of the middle portion due to excessive compression of the elastic unit 30, such that the cover 5 of the portable terminal 1 can be smoothly opened or shut and durability of the elastic unit 30 is increased.

Further, in this exemplary embodiment, the elastic support plate 60 is stably connected with the rotary plates 40, such that movement and operation of the elastic unit 30 is stable, and assembly and manufacture of the entire configuration is easy with productivity improved.

While this invention has been described in connection with what is presently considered to be practical exemplary embodiments, it is to be understood that the invention is not limited to the disclosed embodiments, but, on the contrary, is intended to cover various modifications included within the claims, the detailed description, and the accompanying drawings, which are included within the range of the spirit of the present invention.

What is claimed is:

1. A slide-type cover opening and shutting device for a portable terminal, comprising:
a plate-shaped guide member;
a plate-shaped movable member that is slidably assembled to the guide member; and
an elastic member of which ends are rotatably connected to the guide member and the movable member, respectively,
wherein the elastic unit includes:
a pair of rotary plates that cross in parallel with each other and are rotatably connected to the guide member and the movable member by hinge pins;
elastic support plates that are connected to both sides of the rotary plates between the rotary plates to be able to slide and lock, that are composed of first and second slide sections that are open to opposite directions toward the rotary plates, and that have a plurality of support pins that are partially inserted in the rotary plates at the first and second slide sections; and
elastic members that are fitted on the support plates and apply elastic reaction force to the rotary plates.

2. The slide-type cover opening and shutting device for a portable terminal of claim 1, wherein the elastic support plates are formed to open ends of the first and second slide sections, corresponding to both sides of the rotary plates, and have hook protrusions that are hooked to both sides of the rotary plates.

3. The slide-type cover opening and shutting device for a portable terminal of claim 2, wherein each of the rotary plates has a guide rail where the first and second slide sections are slidably connected at both sides thereof, and locking projections are formed on the guide rail to lock the hook protrusions.

4. The slide-type cover opening and shutting device for a portable terminal of claim 3, wherein the hook protrusions have a predetermined inclination to be combined with the locking projections.

5. The slide-type cover opening and shutting device for a portable terminal of claim 3, wherein the guide rail is composed of a first rail facing the inside of open ends of the first and second slide sections from the locking projection and a second rail facing the outside of the open ends.

6. The slide-type cover opening and shutting device for a portable terminal of claim 2, wherein the open ends of the first and second slide sections are rounded.

7. The slide-type cover opening and shutting device for a portable terminal of claim 1, wherein
the elastic support plate includes:
a first rib that is slidably connected to a side of the rotary plate corresponding to the first slide section;
a second rib that is slidably connected to a side of the other rotary plate corresponding to the second slide section; and
a third rib that is slidably connected to the other side of rotary plates between the first rib and the second rib, and is integrally formed with the first rib and the second rib.

8. The slide-type cover opening and shutting device for a portable terminal of claim 1, wherein the elastic support plate is formed in an S-shape.

9. The slide-type cover opening and shutting device for a portable terminal of claim 1, wherein the elastic support plate is formed of a thin metal plate having elasticity.

10. The slide-type cover opening and shutting device for a portable terminal of claim 1, wherein each of the rotary plates has a main body with insertion holes where the support pins are inserted, and an extension that extends from both sides of the main body at the sides of the insertion holes.

11. The slide-type cover opening and shutting device for a portable terminal of claim 10, wherein hinge grooves are formed in the main body of the rotary plate to fit the hinge pins.
